(19) United States
(12) Patent Application Publication
(10) Pub. No.: US 2010/0304722 A1
(43) Pub. Date: Dec. 2, 2010

(54) IMAGE-PROJECTABLE MOBILE INFORMATION DEVICE AND NOTIFICATION METHOD THEREOF

(76) Inventor: Ryuichiro Tanaka, Hamura-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/627,773

(22) Filed: Nov. 30, 2009

(30) Foreign Application Priority Data
May 29, 2009 (JP) 2009-131566

(51) Int. Cl. H04M 3/42; H04M 1/00

(52) U.S. Cl. 455/414.1; 455/566

(57) ABSTRACT

According to an aspect of the present invention, there is provided an image-projectable mobile information device including: a wireless communication unit that wirelessly communicates through a wireless channel; a projection unit that performs an image projection on a projection face; a communication reception notification method selection unit that selects a communication reception notification method that is referred when a communication is received though the wireless channel, the communication reception notification method including a setting of whether or not a vibration is performed; and a communication reception notification unit that notifies a receiving of communication by displaying a communication reception notification picture indicating the receiving of communication on the projection face by the projection unit without performing the vibration even when the communication reception notification method is set to perform the vibration, if the communication is received during the image projection.

### CROSS-REFERENCE TO RELATED APPLICATIONS

This application is based upon and claims the benefit of priority from Japanese Patent Application No. 2009-131566, filed on May 29, 2009, the entire contents of which are incorporated herein by reference.

### BACKGROUND

1. Field

An aspect of the present invention relates to a mobile information device with a projection function.

2. Description of the Related Art

As is widely known, recently, in mobile information devices represented by mobile phones which have come into wide use on the market, in addition to the original telephone function, various functions are built therein, using information communication functions such as an e-mail function, a camera function, and a one-segment television broadcasting receiving function. When electric power is supplied to such mobile information communication devices, the mobile information device enters a standby mode. Accordingly, when receiving a phone call, a mail, or the like, generally, a user is notified of a call by a ring. However, there is a case where the ring at the time of reception joins the background noise due to the surrounding circumstances. In this case, it is possible to set a so-called “manner mode” (“silent mode”) to perform such notification by vibration without a ring.

Currently, research is being undertaken to build, in the mobile information device, a projection function of enlarging and projecting an image in order to display the image to the outside.

In JP-2004-289401-A, in a mobile phone with a projection unit, a technique of notifying a user of a call by projecting onto a call notifying screen by the projection unit, in order to prevent noise when receiving a call is disclosed.

In JP-2008-219256-A, an information communication device is disclosed which projects an image of a displayed picture by a projection device, when receiving a call during viewing an image or the like displayed on a display screen of the information communication device.

In JP-2007-074652-A, in a mobile phone with a projection unit, as a notification method when receiving a call, there is disclosed a technique in which one option is selected in advance from “notifying by projection”, “notifying by sound”, “notifying by vibration”, and the like, and, when “notifying by projection” is selected, display of a projection notification picture at the time of reception is started or displayed by overlapping with a projecting image.

However, in JP-2004-289401-A and JP-2008-219256-A, a call reception display screen at the time of reception or projection of the screen displayed on a display unit is disclosed, but an operation during projection is not disclosed.

In JP-2007-074652-A, when “notifying by sound” or “notifying by vibration” is selected as the set call notification method, a ring or vibration is generated when receiving a call even during the projection of an image from the projection unit. For this reason, the position of the mobile information terminal device is out of alignment due to the vibration and thus the mobile information terminal device may be out of focus. In addition, noise is caused by the vibration at the installation position. Moreover, noise is caused by the ring during the image projection.

### BRIEF DESCRIPTION OF DRAWINGS

A general architecture that implements the various feature of the present invention will now be described with reference to the drawings. The drawings and the associated descriptions are provided to illustrate embodiments of the present invention and not to limit the scope of the present invention.

FIG. 1 illustrates an exemplary appearance of an image-projectable mobile phone according to an embodiment of the invention.

FIG. 2 illustrates an exemplary block diagram of the mobile phone 1 according to the embodiment.

FIG. 3 illustrates an exemplary block diagram of a storage unit 60 according to the embodiment.

FIG. 4 illustrates an example of a notification method according to the embodiment.

FIG. 5 illustrates an example of phone book registration according to the embodiment.

FIGS. 6A and 65 illustrate an example of a simple display when receiving a communication according to the embodiment.

FIGS. 7A and 75 illustrate an example of a detailed display when receiving a communication according to the embodiment.

FIG. 8 illustrates an exemplary process flow when receiving a communication according to the embodiment.

FIG. 9 illustrates an example of schedule registration according to the embodiment.

FIG. 10 illustrates an example of alarm registration according to the embodiment.

FIGS. 11A and 115 illustrate an example of a simple display of a schedule/alarm according to the embodiment.

FIGS. 12A and 12B illustrate an example of a detailed display of a schedule/alarm according to the embodiment.

FIG. 13 illustrates an exemplary process flow at the time of sounding an alarm according to the embodiment.

### DETAILED DESCRIPTION

Various embodiments according to the present invention will be described hereinafter with reference to the accompanying drawings. In general, according to one embodiment of the present invention, there is provided an image-projectable mobile information device including: a wireless communication unit that wirelessly communicates through wireless channel; a projection unit that performs an image projection on a projection face; a communication reception notification method selection unit that selects a communication reception notification method that is referred when a communication is received though the wireless channel, the communication reception notification method including a setting of whether or not a vibration is performed; and a communication reception notification unit that notifies a receiving of communication by displaying a communication reception notification picture indicating the receiving of communication on the projection face by the projection unit without performing the vibration even when the communication reception notification method is set to perform the vibration, if the communication is received during the image projection.

Hereinafter, embodiments of the invention will be described in detail with reference to the drawings.

In a first embodiment, an image-projectable mobile information device will be described.

The image-projectable mobile information device is provided with a network access function, an e-mail function, a camera function, a ringer melody function using contracted music data downloaded from the network or a PC (personal computer), an audio player function of reproducing the music data as music, an “one-segment” (a mobile television broadcasting service in Japan) television broadcasting receiving function, and the like, in addition to the most basic telephone function. As other functions, the image-projectable mobile information device is provided with a function of registering a schedule using calendar and clock functions, and an alarm clock function of ringing an alarm at a preset time. Further, the image-projectable mobile information device is provided with a projection function. In the embodiment, the functions other than the projection function may be built as necessary, and not all the functions are necessarily built.

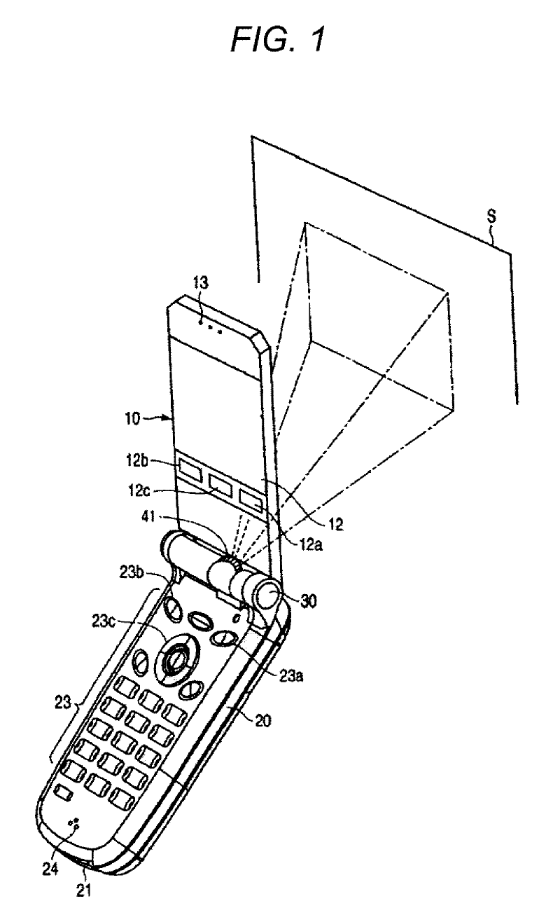

FIG. 1 illustrates an exemplary appearance of an image-projectable mobile phone 1 as the mobile information communication device according to the embodiment.

The image-projectable mobile phone 1 is provided with a display unit 10 having, for example, an LCD (liquid crystal display) panel or an EL (electroluminescent) panel and an imaging lens, and a main unit 20. The display unit 10 and the main unit 20 are connected by a connection portion 30 formed of a hinge or the like, and the display unit 10 is formed to be opened with respect to the main unit 20. A projector lens 41 projecting an image at the time of using the mobile phone as a projection device is provided at a given position on the main unit 20 in the vicinity of the connection portion 30. The projector lens 41 is not limited to one position, and may be provided at any position. In addition, the projector lens 41 may be provided as a unit separate from the mobile phone device 1, and may be connected thereto as necessary.

A display 12 capable of displaying a phone call destination, the phone number of the person to be contacted, a data transmission destination, an address of a sending source, text information or image information during editing or reproduction, or the like, and a speaker 13 used for a voice phone call or reproduction of music data are provided on a face of the display unit toward the main unit 20 of the display unit 10.

The main unit 20 is provided with a key input unit 23 used to input numerical values or text information, and a microphone 24 used for a voice phone call. Although not described, the key input unit 23 is provided with various keys such as numerical (dial) keys used to input phone numbers of people to be contacted or numerical data, a sending key, an end key, a power key, a volume control key, a mode setting key, and various setting keys used to set various functions or to specify operation states. Multifunction keys 23a, 23b, and 23c of the input unit 23 can be used to input commands such as selection/return, scroll/switch, determination, corresponding to, for example, GUIs (Graphical User Interface) 12a, 12b, and 12c displayed at a given position of the display 12 of the display unit 10, and are capable of various input operations corresponding to information displayed on the display 12. In addition, to select a notification method when receiving a communication, it is possible to set and release a “manner mode” (a mode corresponding to “silent mode”, in which cell phone only vibrates and not rings, for example) for notifying a user of receiving of a communication without a ring by operating the given keys of the input unit 23.

The main unit 20 is provided with an external connection portion 21 to which electric power is supplied from a charger (not shown) or an external battery (not shown), and the external connection portion has a function as a connector used to connect to external devices and to transmit and receive information to and from the external devices.

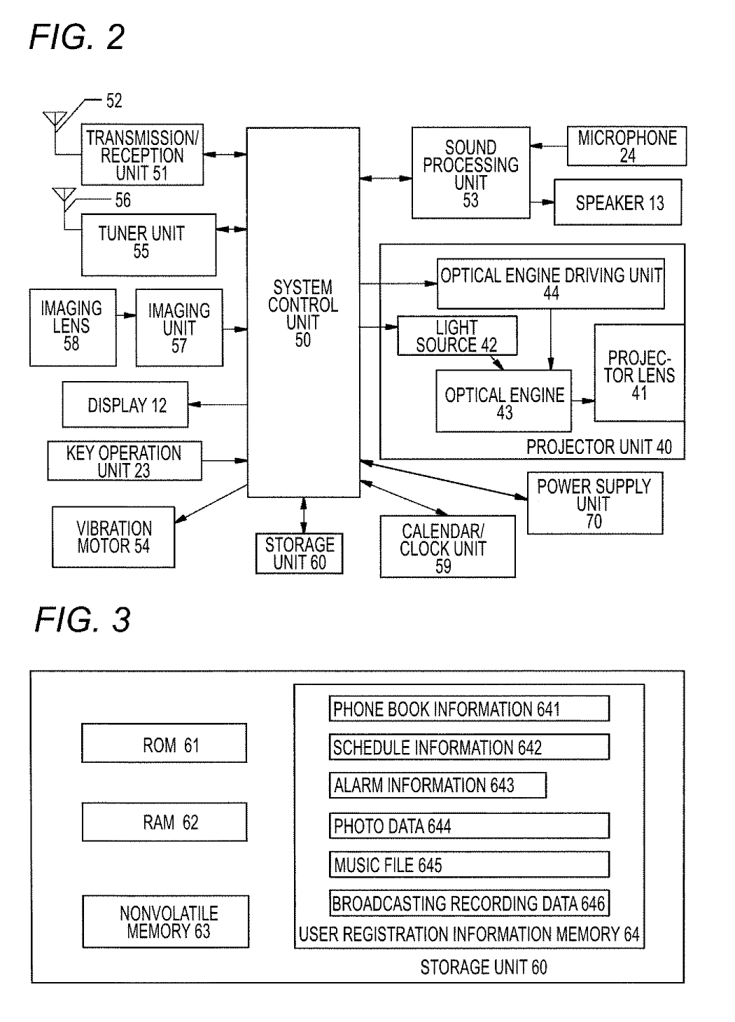

FIG. 2 shows a block diagram of the mobile phone 1. The mobile phone 1 is provided with a control unit 50 that generally controls all the functions thereof. The control unit 50 has, for example, a CPU (central processing unit) built therein, receives operation information from the key input unit 23, and controls each unit so as to perform the operation.

The control unit 50 is connected to a wireless communication unit 51 to transmit and receive wireless signals to and from a base station (not shown) through an antenna 52 and wireless signals. The control unit 50 is connected to a sound processing unit 53, and the sound processing unit 53 is connected to the microphone 24 and the speaker 13. The control unit 50 controls the sound processing unit 53 to process sound obtained from the microphone 24 by a given sound signal process and controls the wireless communication unit 51 to modulate the processed sound signals to radio frequency signals, and the radio frequency signals are transmitted to the base station (not shown) through the antenna 52. The radio frequency signals received from the base station (not shown) by the antenna 52 are demodulated by the wireless communication unit 51, and the control unit 50 supplies the demodulated signals to the sound processing unit 53 and reproduces the signals as sound signals through the speaker 13. Accordingly, the control unit 50 realizes the telephone function.

The control unit 50 controls the transmission and reception of e-mails through the wireless communication unit and the antenna 52. In this case, the control unit 50 controls the display 12 to display the texts of the transmitted and received mails.

The control unit 50 is provided with a vibration motor 54 for notifying a user by vibration when receiving a call from the base station or receiving a mail.

The control unit 50 is connected to a tuner unit 55. The tuner unit 55 selects broadcasting signals of a given channel from one-segment television broadcasting signals received through the antenna 56, demodulates the signals, generates video signals and audio signals, and supplies the signals to the control unit 50. For this reason, the control unit 50 controls the display 12 to display images on the basis of the video signals and controls the speaker 13 to reproduces sound on the basis of the audio signals, thereby realizing the one-segment television broadcasting receiving function.

The control unit 50 is connected to an imaging unit 57. The imaging unit 57 generates video signals corresponding to an optical image of a subject for photography put through an imaging lens 58, and supplies the video signals to the control unit 50. The control unit 50 stores the video signals supplied from the imaging unit 57 in a storage unit 60, thereby realizing the camera function.

The control unit 50 is connected to a projector unit 40. The projector unit 40 includes a light source 42 generating light for projecting an image, an optical engine 43 forming a projection image by performing optical modulation on the light generated from the light source 42, an optical engine driving unit 44 driving the optical engine 43 for the displayed image, and a projector lens 41.

In the embodiment, the projector unit 40 has a function as a communication reception notification unit by displaying a communication reception notification picture when receiving a communication of a voice call or an mail, in addition to the function of enlarging, projecting, and displaying data such as texts transmitted and received using the e-mail function, the video imaged using the camera function, the video of the television broadcasting program received using the television broadcasting receiving function, the video input from the outside, and the files stored therein, through the projector lens 41 onto a given projection face as described above.

As an example of the light source, a laser generator or the like is used from the viewpoint of miniaturization but the light source 42 is not limited to the laser. Lamp light or an LED (light emitting diode) may be used if it can be mounted and the necessary quantity of light can be obtained. As an example of the optical engine 43, an image DLP system or liquid crystal is used, but the invention is not limited thereto. The projector unit 40 may be provided separately from the mobile phone 1 to be detachable.

The control unit 50 is connected to a calendar/clock unit 59. The calendar/clock unit 59 is used to manage a schedule or set an alarm registered as needed by the user when receiving a communication (reception of a voice call or reception of a mail).

The control unit 50 is connected to a storage unit 60 for storing various kinds of information. FIG. 3 illustrates an exemplary block diagram of the storage unit 60. As shown in FIG. 3, the storage unit 60 mainly includes a ROM (read only memory) 61 storing a control program executed by the CPU, a RAM (random access memory) 62 to provide a work area of the CPU, a nonvolatile memory 63 storing various kinds of setting information and control information, and a user information storage memory 64 storing data registered mainly by the user. The user information storage memory 64 also stores phone book information 641 registered in advance by the user, schedule information 642 registered by the user to manage a schedule, alarm information 643 registered to notify the user when it becomes the registered time such as by an alarm clock, photograph data 644 imaged by the user, user registration data 645 including music information transmitted from a PC or the like, and broadcasting recording data 646 recording the one-segment broadcasting. For example, the user information storage memory 64 may be formed of a built-in flash memory, and a HDD. In addition, a detachable card such as a micro SD card may be used. In addition, the built-in memory such as the flash memory, the micro SD card, and the like may be used together.

The mobile phone 1 is connected to a power supply unit 70. The power supply unit 70 has a battery built therein, and is connected to a charger (not shown). When electric power is supplied from the outside to the mobile phone 1, the battery of the power supply unit 70 is charged and electric power is supplied to each unit. When the external power supply is not connected, the charged electric power is supplied from the battery to each unit in the main body of the mobile phone 1.

In such a configuration, when the wireless communication unit 51 receives a phone call as sound communication or receives a mail (hereinafter, referred to as “receiving of communication”), communication reception notification is performed by a method depending on whether or not the manner mode is set and the information registered in the phone book information, as a communication reception notification method selecting unit. In the embodiment, the method set by the communication reception notification selecting unit is changed in accordance with to whether or not the projector unit 40 performs projection.

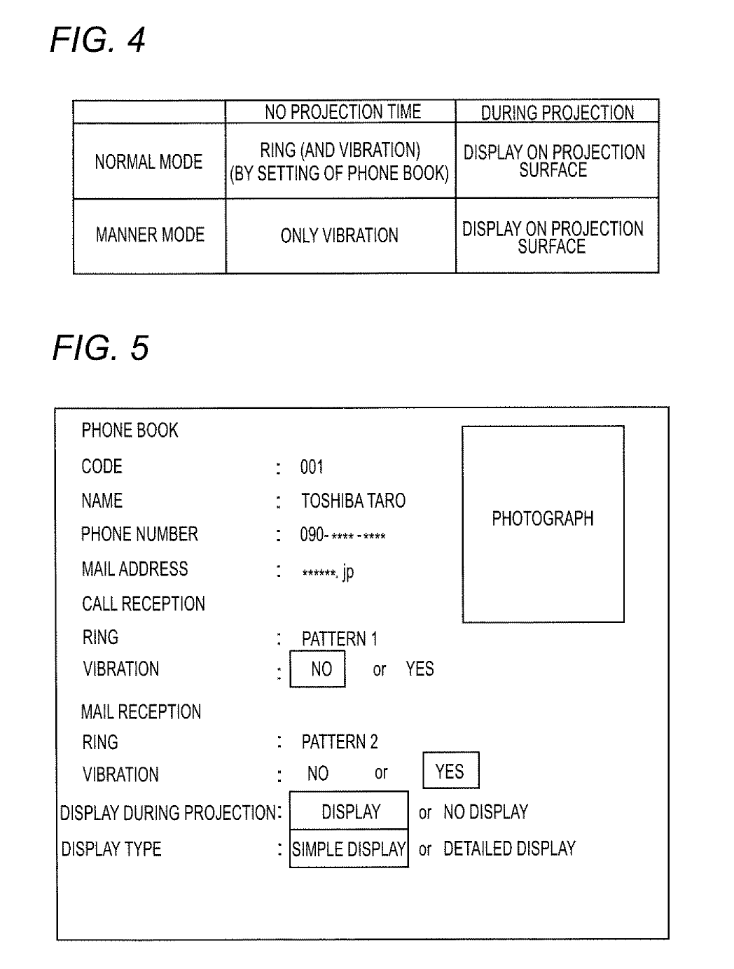

In such a configuration, FIG. 4 shows the method of notifying the user when the wireless communication unit 51 receives the phone call as the sound communication or receives the mail (hereinafter, referred to as “receiving of communication”).

In the embodiment, when the projector unit 40 does not project an image or the like, the user is notified of the receiving of communication by the generation of a ring (also by vibration in the case of generating vibration according to the setting of the phone book information 641) in a normal mode. When the manner mode is set by the operation of the key input unit 23, the user is notified of the receiving of communication solely by the vibration without the ring.

When the projector unit 40 performs the projection, the projector unit 40 only performs display on the projection face, and neither ringing nor vibration are generated no matter whether the setting of the communication receiving method is the normal mode or the manner mode, in the embodiment.

Hereinafter, an example of the registration of the phone book will be described with reference to FIG. 5. The phone book information 641 is stored in the user registration information memory 64 of the storage unit 60, and information about a sender such as “code number”, “name”, “phone number”, “mail address”, and the like can be registered therein. These items may be expanded as necessary. For example, a face photograph imaged by the camera function may be registered in the phone book 641 as individual information.

In addition, it is possible to set a ring in the case of “call reception” (selection of pattern, or selection of ringer melody using recorded music files), or to select vibration, as the setting items of the phone book 641. In the same manner as the case of “mail reception”, it is possible to select the ring and to select whether or not vibration is set. By setting “display at the projection time”, it is possible to set whether or not to display receiving of communication on the projection screen when the projector unit 40 projects an image, and to set whether the display content is set to “simple display” or “detailed display” when the receiving of communication is displayed.

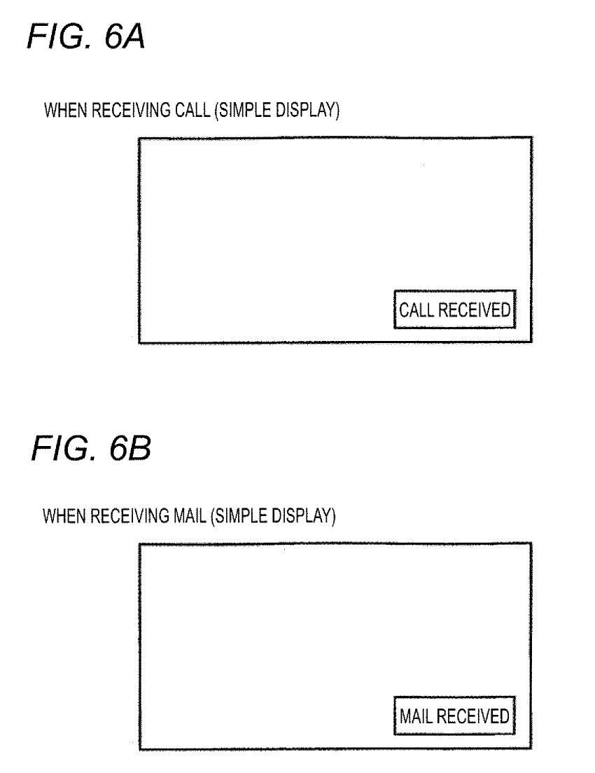

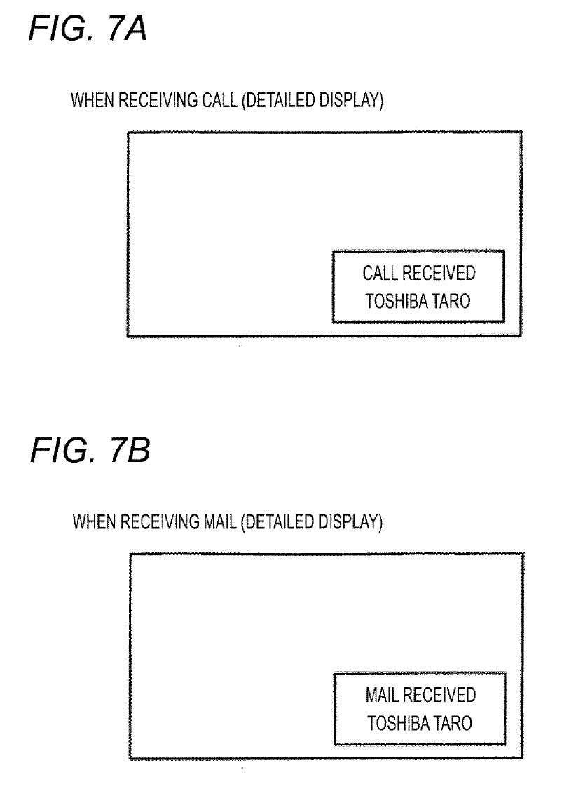

FIGS. 6A and 6B show an example of the simple display, and FIGS. 7A and 7B show an example of the detailed display.

The simple display shown in FIGS. 6A and 6B display only the receiving of communication (or notification of reaching a time registered in the schedule), which does not include the name, the phone number, and the like as the individual information of the sender. FIG. 6A shows an example of the call reception, and FIG. 6B shows an example of the mail reception. “Call reception” and “mail reception” may be displayed using icons instead of text information. As shown in FIGS. 6A and 6B, the position of the display may be any one of a peripheral portion and a center portion of the projection screen.

Meanwhile, the detailed display shown in FIGS. 7A and 7B are a method of immediately recognizing where the communication is received from, by including the individual information of the sender in the communication reception display screen. FIG. 7A shows an example of the call reception, and FIG. 75 shows an example of the mail reception. Also in this case, “call reception” and “mail reception” may be displayed using icons instead of text information. The detailed display includes the name, the phone number, and the like as the individual information of the sender in order to aid immediate recognition of the sender. In the case of having a function capable of registering a face photograph in the phone book, the face photograph may be displayed on the communication reception display screen.

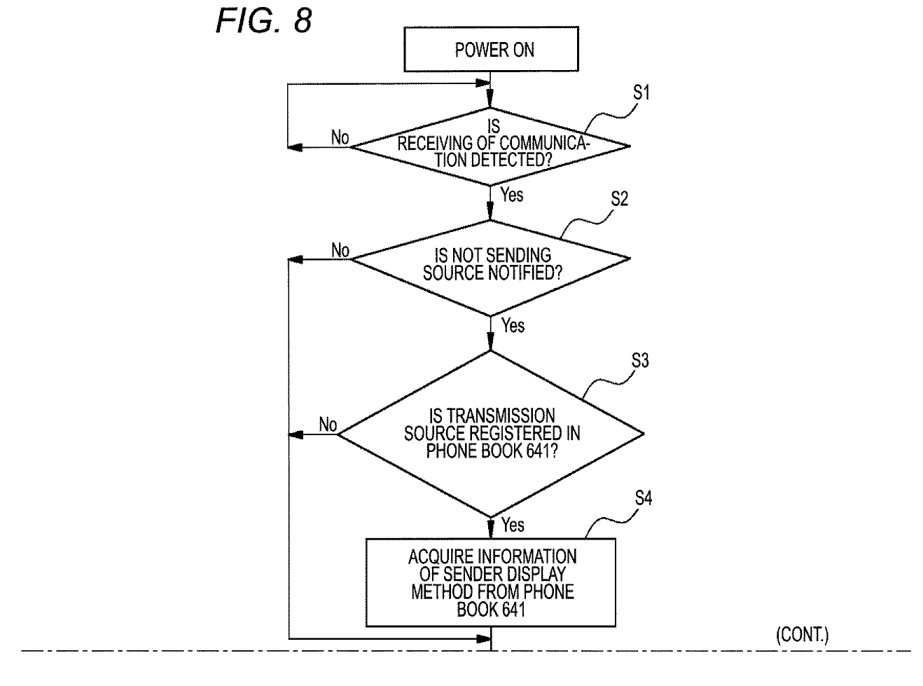

FIG. 8 shows an exemplary flowchart of a process when receiving a communication.

In FIG. 8, when electric power is supplied, the wireless communication device 1 operates in a standby state. Then, the control unit 50 starts monitoring whether or not there is communication. In this state, when the receiving of communication (call reception or mail reception) is detected (S1), the control unit 50 detects whether or not there is sender information from signals of communication received through the antenna 52 and the wireless communication unit 51 (S2). When there is notification of the transmission source information, it is confirmed whether or not the transmission source information is registered in the phone book in the user information storage memory 63 of the storage unit 60 (S3). When the transmission source information is registered, information for a sender display method is acquired (S4).

Next, the control unit 50 determines whether or not the projector unit 40 is performing projection (S5).

When the projector unit 40 is not performing the projection, it is determined whether or not the manner mode is set (S6). When the manner mode is not set, the control unit 50 performs display on the display 12 and notification by a ring (also vibration in the case where the sender display method acquired in S4 is set to perform vibration) (S7). Also in the case of transmission source non-notification or phone book non-registration, a user is notified of the receiving of communication by a ring (S8).

In S6, when the manner mode is set, the control unit operates the vibration motor S4 to perform the communication reception notification by vibration without a ring.

In S5, in the case of projecting, it is determined whether or not the display method at the time of imaging in S4 could be acquired by the phone book information (S9). When the phone number information could not be acquired, the display method at the time of projection is confirmed from the registered phone book information (S10).

In the case where the phone book information cannot be acquired because the received communication does not have notification or because a sender of the communication is not registered in the phone book in S9, and also in the case of “no display” in S10, the display is not performed on the projection screen (S11) but only on the display 12. In this case, the projection of the projector unit 40 is ended, and then a sending source is confirmed according to need.

In the case of “display” in S10, the display method registered in the phone book is confirmed (S12).

In the case of “detailed display (no vibration)”, the display including the individual information of the sender as shown in FIGS. 7A and 7B is performed without a vibration (S13). In the case of “simple display (no vibration)” in S12, the simple display as shown in FIGS. 6A and 6B is performed without a vibration (S14).

As described above, it is possible to select any one of “no display”, “simple display”, and “detailed display” as the display method at the time when the projector unit 40 is projecting, and thus they can be classified according to the sender. As the usage method of “detailed display”, in the case of waiting for contact from a sender needing emergency contact, “detailed display” is set to immediately discontinue the projection when receiving a communication, thereby quickly responding to the communication reception. As the usage method of “simple display”, when the viewer who is looking at the projection screen does not want to know the caller, the simple display is set and thus it is possible to hide where the communication is received from. For example, as one usage method of “no display”, “no display” is set to give the user privacy by hiding the communication from the other people during subject.

As described above, in the embodiment, even when the manner mode is set or the communication is received from the sender for whom the vibration is set in the phone book, the control unit 50 automatically switches the communication reception notification method to the method of no vibration according to whether or not the projector unit 40 projects an image. For this reason, when the image projection is performed as the projector, there is no case where the mobile phone moves and clatters due to the vibration to cause noise or the projection screen is put out of focus by the vibration so as not to perform the display.

Next, a second embodiment will be described. In the first embodiment, the operation at the time of the communication reception such as call reception and mail reception has been described. In the present embodiment, a case of registering a schedule in the schedule information 642 by a schedule management function from the key input unit 23 as a set time registering unit or a case of registering alarm information by an alarm function (function of notification at a registered time) will be described.

First, the configuration of the device is the same as that of FIG. 2, and thus the description thereof is omitted.

In the embodiment, the key input unit 23 serves as a time registration setting unit, and the projector unit 40 serves as a set time notification unit that notifies a user that the set time has been reached.

Hereinafter, a method of setting a schedule and a method of setting an alarm will be described as a set time registration unit.

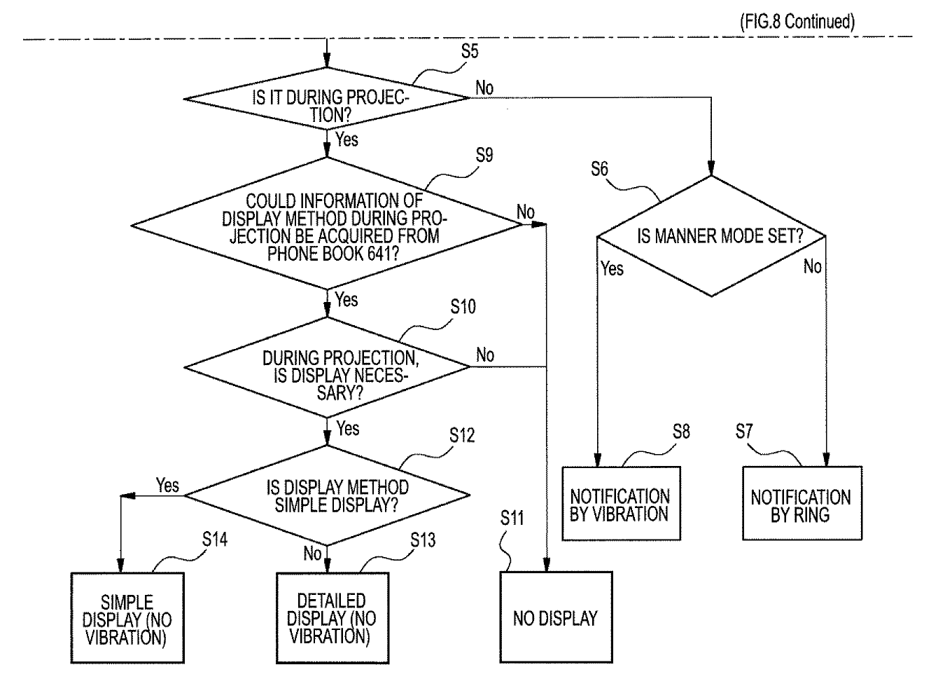

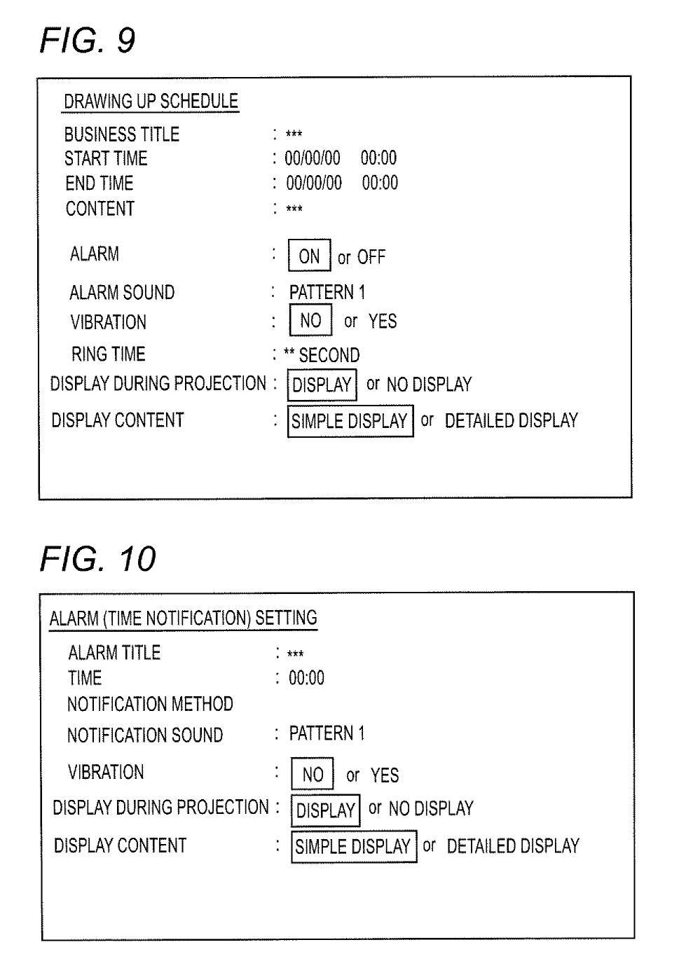

First, an example of registering a schedule will be described with reference to FIG. 9.

The schedule is input through an input operation of selecting a given menu on the display 12 of the display unit 10 using the key input unit 23. The schedule information 642 is stored in the user registration information memory 64 of the storage unit 60, and it is possible to register information such as “subject title”, “start time”, “end time”, “content”, and “alarm”. As a setting item when “alarm” is set to ON, it is possible to set a ring (selection of pattern, or selection of ringer melody using recorded music files) or to select vibration and ring time. In addition, it is possible to set whether or not the receiving of communication is displayed on the projection screen when the projector unit 40 is projecting an image by setting “display at the time of projection”. When the receiving of communication is displayed, it is possible to set whether the content is displayed by “simple display” or “detailed display”. In addition, it is possible to confirm the schedule registered by a method such as calendar display on the display 12 by operating a given key from the key input unit 23. This item may be expanded as necessary.

An example of registering alarm (notification at a set time) information will be described with reference to FIG. 9. The alarm information 643 is stored in the user registration information memory 64 of the storage unit 60, and it is possible to register information such as “alarm title”, “time”, and “notification method”.

As the setting item of “notification method”, it is possible to set a ring (selection of pattern, or selection of ringer melody using recorded music files), or to select vibration and ring time. In addition, it is possible to set whether or not the receiving of communication is displayed on the projection screen when the projector unit 40 is projecting an image by setting “display at the time of projection”. When the receiving communication is displayed, it is possible to set whether the content is displayed by “simple display” or “detailed display”. The alarm information can be registered by operating a given key from the key input unit 23. This item may be expanded as necessary.

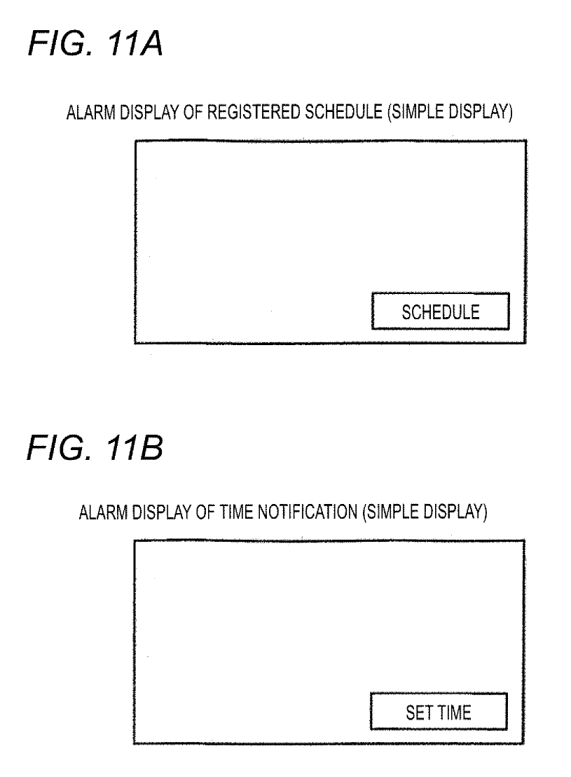

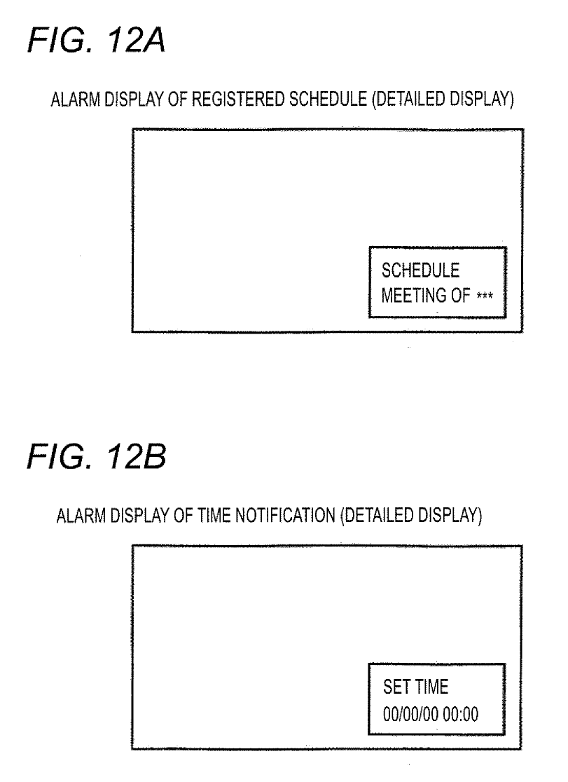

FIGS. 11A and 11B show an example of the simple display of schedule/alarm, and FIGS. 12A and 12B show an example of the detailed display of schedule/alarm.

The simple display of schedule/alarm shown in FIGS. 11A and 11B only display that the time of the schedule registered by the schedule management function, or the time set by the alarm function, has been reached and does not include the content of the schedule or alarm. FIG. 11A shows an example of notifying a user that the start time (or end time) of the registered schedule has been reached, and FIG. 11B shows an example of an alarm display of time notification. In this case, “schedule” and “set time” may be displayed using icons instead of text information. As shown in FIGS. 11A and 11B, the position of the display may be any one of a peripheral portion and a center portion of the projection screen.

The detailed display of the schedule/alarm shown in FIGS. 12A and 12B include the content of the schedule/alarm together and displays such on the communication reception display screen, which is a method capable of allowing immediate recognition of the content. FIG. 12A shows an example of notifying a user that the start time (or end time) of the registered schedule has been reached, and FIG. 128 shows an example of the alarm display of the time notification. Also in this case, “schedule” and “set time” may be displayed using icons instead of text information.

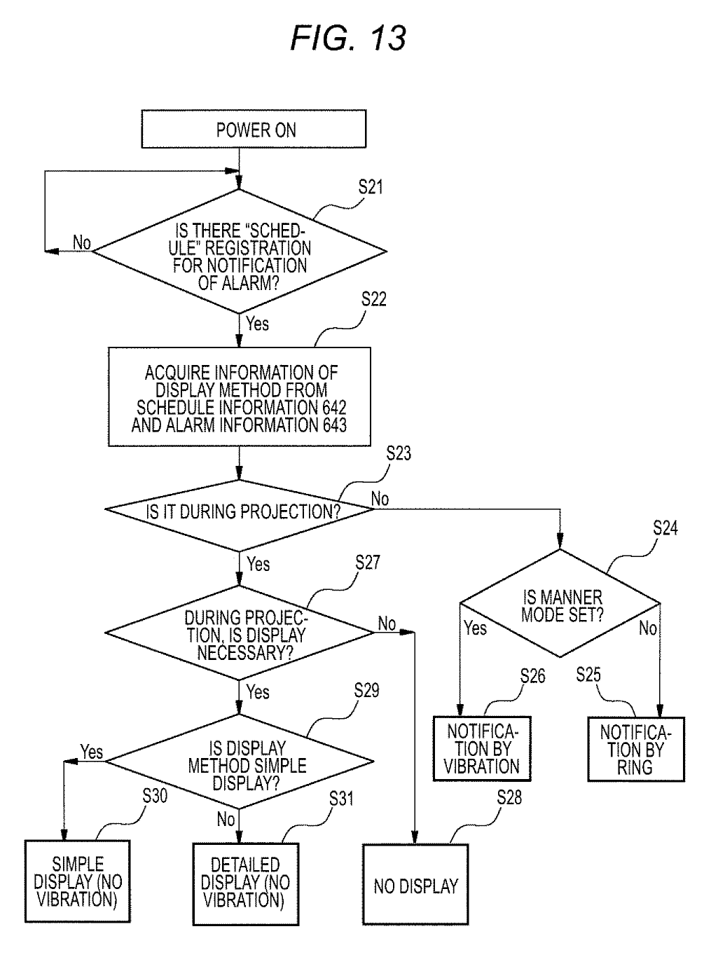

FIG. 13 shows a flowchart for explaining a process of the schedule/alarm notification.

In FIG. 13, when electric power is supplied, the wireless communication device 1 operates in a standby state. Then, the control unit 50 starts monitoring whether or not there is communication as described in FIG. 8, and monitors whether or not there is alarm information to notify the schedule information 642 and the alarm information 643 (S21). In this state, when alarm information (schedule information) for notification is detected or when a notification time of the alarm clock and the like is detected, the control unit 50 acquires the display method information from the schedule information 642 or the alarm information 643 of the user information storage memory 64 (S22).

Then, the control unit 50 determines whether or not the projector unit 40 is projecting (S23).

When the projector unit 40 is not projecting, it is determined whether or not the manner mode is set (S24). When the manner mode is not set, the control unit 50 controls the display 12 to perform display and notifies a user by a ring (also vibration in the case where the acquired sender display method in S22 is set to vibrate together with the ring) (S25). In S24, when the manner mode is set, the control unit 50 controls the vibration motor 54 to operate, thereby performing communication reception notification by vibration without a ring (S26).

In S23, when the projector unit 40 is projecting, the display method at the time of projection is confirmed from that registered in the phone book information (S27). In S27, when “no display” is set, the display is not performed on the projection screen (S28), but only on the display 12. In this case, the projection of the projector unit 40 is ended, and then a sending source is confirmed according to need.

In the case of “display” in S27, the registered display method is confirmed (S29). In the case of “detailed display”, the display including the content of the alarm as shown in FIGS. 12A and 128 is performed (S31). In the case of “simple display” in S29, the simple display is performed as shown in FIGS. 12A and 12B (S30).

In the same manner, also in the case of the notification of the alarm, it is possible to select any one of “no display”, “simple display”, and “detailed display” as the display method at the time when the projector unit 40 is projecting, and thus they can be classified according to the sender.

As described above, in the embodiment, even when the manner mode is set or the alarm is generated for the registered schedule or time notification, the control unit 50 automatically switches the notification method to the method of no vibration according to whether or not the projector unit projects an image. For this reason, when the image projection is performed as the projector, there is no case where the mobile phone moves and clatters due to the vibration to cause noise or the projection screen is put out of focus by vibration so as not to perform the display.

The second embodiment is an example of the application of the alarm to the schedule registered by a user or the time notification. Accordingly, in the second embodiment, the telephone function as the first embodiment is not necessarily required. For this reason, the embodiment can be applied to a small-size projection device having no telephone function if the projection device is configured to perform the alarm notification.

The invention is not limited to the above-described embodiments. In the embodying step, the constituent elements may be variously modified and embodied within the scope of the invention. In addition, it is possible to form various inventions by appropriately combining the plurality of constituent elements described in the embodiments. For example, several constituent elements may be omitted from the former constituent elements described in the embodiments. Moreover, the constituent elements related to the different embodiments may be combined as appropriate.

What is claimed is:

1. An image-projectable mobile information device comprising:
a wireless communication unit that wirelessly communicates through a wireless channel;
a projection unit that performs an image projection on a projection face;
a communication reception notification method selection unit that selects a communication reception notification method that is referred when a communication is received though the wireless channel, the communication reception notification method including a setting of whether or not a vibration is performed; and
a communication reception notification unit that notifies a receiving of communication by displaying a communication reception notification picture indicating the receiving of communication on the projection face by the projection unit without performing the vibration even when the communication reception notification method is set to perform the vibration, if the communication is received during the image projection.

2. The image-projectable mobile information device of claim 1,
wherein the communication reception notification method selection unit is capable of selecting a manner mode as the communication reception notification method, the manner mode notifying the receiving of communication by performing the vibration without performing a ringing, and
wherein, even when the manner mode is set, the communication reception notification unit notifies the receiving of communication by displaying the communication reception notification picture without performing the vibration if the communication is received during the image projection.

3. The image-projectable mobile information device of claim 1,
wherein the communication reception notification picture is displayed so as to hide information specifying a sender.

4. An image-projectable mobile information device comprising:
a projection unit that performs an image projection on a projection face;
a set time registering unit that selects and registers a set time notification method that is referred when a set time is reached, the set time notification method including a setting of whether or not a vibration is performed; and
a set time notification unit that notifies a coming of set time by displaying a set time notification picture indicating the coming of set time on the projection face by the projection unit without performing the vibration even when the set time notification method is set to perform the vibration, if the set time is reached during the image projection.

5. The image-projectable mobile information device of claim 4,
wherein the set time registering unit is capable of selecting a manner mode as the set time notification method, the manner mode notifying the coming of set time by performing the vibration without performing a ringing, and
wherein, even when the manner mode is set, the set time notification unit notifies the coming of set time by displaying the set time notification picture without performing the vibration if the set time is reached during the image projection.

6. The image-projectable mobile information device of claim 4,
wherein the set time registering unit registers schedule information, the schedule information including at least a start time.

7. The image-projectable mobile information device of claim 4,
wherein the set time registering unit registers alarm information in which a notification time is registered in advance.

8. The image-projectable mobile information device of claim 4,
wherein the set time notification picture is displayed so as to hide information specifying a content of the set time.

9. A notification method of an image-projectable mobile information device capable of wirelessly communicating through a wireless channel and performing an image projection on a projection face, the method comprising:
setting a communication reception notification method that is referred when a communication is received though the wireless channel, the communication reception notification method including a setting of whether or not a vibration is performed; and
notifying a receiving of communication by displaying a communication reception notification picture indicating the receiving of communication on the projection face without performing the vibration even when the communication reception notification method is set to perform the vibration, if the communication is received during the image projection.

10. A notification method of an image-projectable mobile information device capable of performing an image projection on a projection face, the method comprising:
selecting and registering a set time notification method that is referred when a set time is reached, the set time notification method including a setting of whether or not a vibration is performed; and
notifying a coming of set time by displaying a set time notification picture indicating the coming of set time on the projection face without performing the vibration even when the set time notification method is set to perform the vibration, if the set time is reached during the image projection.
